(19) United States
(12) Patent Application Publication
(10) Pub. No.: US 2024/0026922 A1
(43) Pub. Date: Jan. 25, 2024

(54) BALL BEARING

(71) Applicant: HL MANDO CORPORATION, Gyeonggi-do (KR)

(72) Inventor: Donghwan SEO, Gyeonggi-do (KR)

(21) Appl. No.: 18/224,029

(22) Filed: Jul. 19, 2023

(30) Foreign Application Priority Data
Jul. 20, 2022 (KR) 10-2022-0089861

(51) Int. Cl. F16C 19/16; F16C 33/41; F16C 33/60; F16C 33/58

(52) U.S. Cl. CPC F16C 19/163; F16C 33/41; F16C 33/60; F16C 33/585

(57) ABSTRACT

A ball bearing may include an outer ring having a plurality of outer ring orbit grooves formed in an inner circumferential surface of the outer ring, an inner ring having a plurality of inner ring orbit grooves formed in an outer circumferential surface of the inner ring, a plurality of balls each having an outer ring contact surface that comes into contact with each of the outer ring orbit grooves and an inner ring contact surface that comes into contact with each of the inner ring orbit grooves, and a cage in which a plurality of cage grooves are formed to maintain predetermined intervals between the plurality of balls in a circumferential direction. An outer ring contact angle formed between the outer ring contact surface and the outer ring orbit groove may be different from an inner ring contact angle formed between the inner ring contact surface and the inner ring orbit groove.

### CROSS-REFERENCE TO RELATED APPLICATION

This application claims the benefit of Korean Patent Application No. 10-2022-0089861, filed on Jul. 20, 2022 in the Korean Intellectual Property Office, the disclosure of which is incorporated herein by reference.

### BACKGROUND

### 1. Field

The present disclosure relates to a ball bearing in which a contact angle of an outer ring and a contact angle of an inner ring are differently formed.

### 2. Description of the Related Art

In general, bearings are used to reduce wear due to friction between various mechanical parts, significantly reduce a friction coefficient between a shaft and the mechanical parts coming into contact with the shaft, and prevent transfer of overload to the mechanical parts while the shaft is rotated at a high-speed for transmitting power, rolling is performed, or the like. In the case of general ball bearings, balls or rollers are disposed between a shaft and a bearing to support the rotating shaft, and the shaft comes into rolling contact with the bearing to reduce friction so that a high-speed operation is suitably performed.

In such bearings, radial bearings and thrust bearings are used according to applications. That is, when a load is applied in a direction perpendicular to a shaft according to a distribution of the load, a radial bearing is adopted and used, and unlikely, when a load is applied in the same direction as a shaft, a thrust bearing is adopted and used. Such bearings are used as important parts used to minimize a coefficient of friction occurring between parts generated during power transmission or blocking.

In vehicles, machinery, or the like, conical roller bearings having high stiffness have been used for parts such as pinion shafts of differential gears (final reducers) of the vehicles to which relatively large load is applied. Recently, since the conical roller bearings have a large rotational torque, the ball bearings with improved stiffness in order for reducing losses are being used frequently. For example, double-row four-point contact ball bearings capable of effectively absorbing both radial loads and axial loads can be proposed.

### SUMMARY

Therefore, it is an aspect of the present disclosure to provide a ball bearing in which a contact angle of an outer ring is formed differently from a contact angle of an inner ring.

The present disclosure is directed to providing a ball bearing in which a contact angle of an inner ring is maintained and a contact angle of an outer ring is changed.

In accordance with one aspect of the present disclosure, a ball bearing includes an outer ring having a plurality of outer ring orbit grooves formed in an inner circumferential surface of the outer ring, an inner ring having a plurality of inner ring orbit grooves formed in an outer circumferential surface of the inner ring, a plurality of balls each having an outer ring contact surface that comes into contact with each of the outer ring orbit grooves and an inner ring contact surface that comes into contact with each of the inner ring orbit grooves, and a cage in which a plurality of cage grooves are formed to maintain predetermined intervals between the plurality of balls in a circumferential direction, wherein an outer ring contact angle formed between the outer ring contact surface and the outer ring orbit groove is different from an inner ring contact angle formed between the inner ring contact surface and the inner ring orbit groove.

The outer ring contact angle may be greater than the inner ring contact angle.

The outer ring contact angle may be defined as an angle (α) between a radial center line (ML) crossing a center of the ball in a radial direction and an outer ring contact line (OL) connecting the center of the ball and an outer ring contract point at which the outer ring orbit groove comes into contact with the outer ring contact surface.

The inner ring contact angle may be defined as an angle (β) between a radial center line (ML) crossing a center of the ball in a radial direction and an inner ring contact line (IL) connecting the center of the ball and an inner ring contact point at which the inner ring orbit groove comes into contact with the inner ring contact surface.

The inner ring contact angle may be in the range of 34° to 36°, and the outer ring contact angle may be in the range of 37° to 45°.

A similitude ratio defined as a ratio of a radius of each of the cage grooves to a diameter of the ball may be in the range of 0.50 to 0.53.

With respect to a radial center line radially crossing a center of the ball, a position of an outer ring contact point between the outer ring orbit groove and the outer ring contact surface may be farther away than that of an inner ring contact point between the inner ring orbit groove and the inner ring contact surface.

An outer ring contact point between the outer ring orbit groove and the outer ring contact surface may be provided as two outer ring contact points at two sides with respect to a radial center line crossing a center of the ball in a radial direction.

An inner ring contact point between the inner ring orbit groove and the inner ring contact surface may be provided as two inner ring contact points at two sides with respect to a radial center line radially crossing a center of the ball.

The outer ring contact angle may be in the range of 40° to 45°, and a similitude ratio defined as a ratio of a radius of each of the cage grooves to a diameter of the ball may be in the range of 0.50 to 0.53.

A curvature of the outer ring orbit groove may be smaller than a curvature of the inner ring orbit groove.

In accordance with another aspect of the present disclosure, a ball bearing includes an outer ring having a plurality of outer ring orbit grooves formed in an inner circumferential surface of the outer ring, an inner ring having a plurality of inner ring orbit grooves formed in an outer circumferential surface of the inner ring, a plurality of balls each having an outer ring contact surface that comes into contact with each of the outer ring orbit grooves to form an outer ring contact angle and an inner ring contact surface that comes into contact with each of the inner ring orbit grooves to form an inner ring contact angle, and a cage in which a plurality of cage grooves are formed to maintain predetermined intervals between the plurality of balls in a circumferential direction, wherein a difference between the outer ring contact angle and the inner ring contact angle of the inner ring contact surface is in the range of 5° to 10°.

The inner ring contact angle may be 35°, and the outer ring contact angle may be in the range of 40° to 45°.

The outer ring contact angle may be 43°.

An outer ring contact point between the outer ring orbit groove and the outer ring contact surface may be provided as two outer ring contact points symmetrically provided at two sides with respect to a radial center line radially crossing a center of the ball, and an inner ring contact point between the inner ring orbit groove and the inner ring contact surface may be provided as two inner ring contact points symmetrically provided at two sides with respect to the radial center line radially crossing the center of the ball.

With respect to a line perpendicular to the radial center line, a position of the inner ring contact point may be farther away than that of the outer ring contact point.

A line connecting the outer ring contact point and the facing inner ring contact point between which the center of the ball is interposed may not cross the center of the ball.

A distance between the two outer ring contact points may be greater than a distance between the two inner ring contact points.

An angle formed by the two outer ring contact points and the center of the ball may be 1.1 to 1.3 times an angle formed by the two inner ring contact points and the center of ball.

A similitude ratio defined as a ratio of a radius of each of the cage groove to a diameter of the ball may be in the range of 0.51 to 0.52.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a ball bearing according to an embodiment of the present disclosure;

FIG. 2 is a cross-sectional view illustrating the ball bearing along line I-I illustrated in FIG. 1;

FIG. 3 is a cross-sectional view illustrating a comparative example of a fast ball bearing; and

FIG. 4 is a view showing experimental data for describing the performance of the ball bearing according to the embodiment of the present disclosure.

### DETAILED DESCRIPTION

Hereinafter, embodiments of the present disclosure will be described in detail with reference to the accompanying drawings. The following embodiments are examples which fully provide the spirit of the present disclosure to those skilled in the art. The present disclosure is not limited to the following embodiments and may be implemented in different forms. Parts irrelevant to description are omitted in the drawings in order to clearly describe the present disclosure, and widths, lengths, thicknesses, and the like of components in the drawings may be exaggerated for convenience of description. In this specification, like reference characters denote like components.

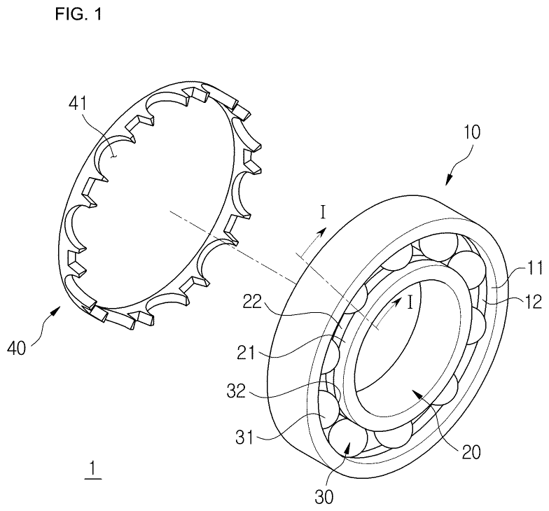

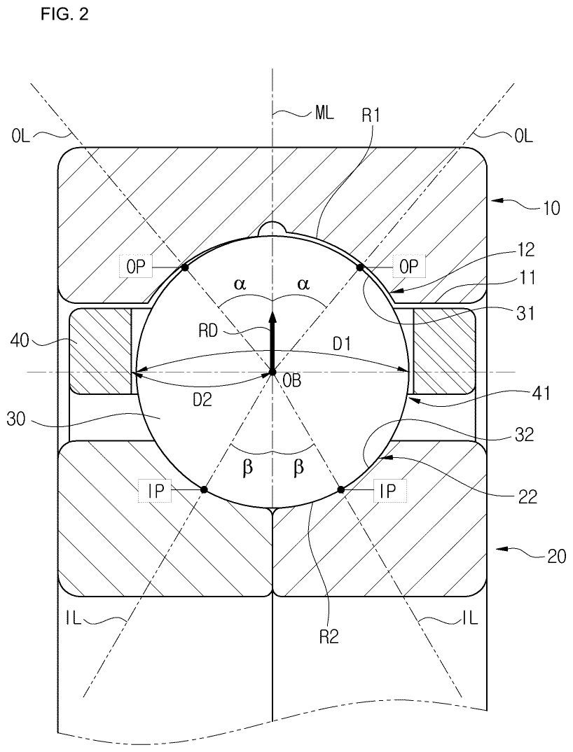

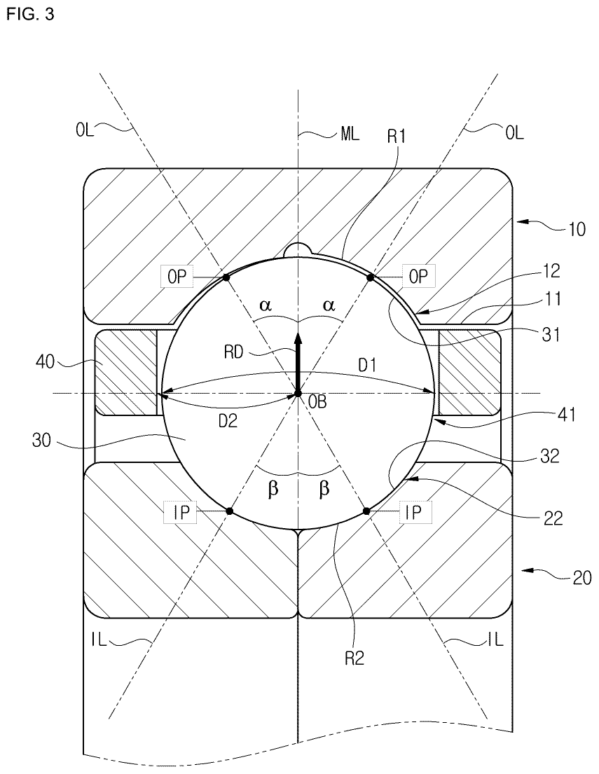

FIG. 1 is a perspective view illustrating a ball bearing according to an embodiment of the present disclosure. FIG. 2 is a cross-sectional view illustrating the ball bearing along line I-I illustrated in FIG. 1. FIG. 3 is a cross-sectional view illustrating a comparative example of a fast ball bearing.

A ball bearing 1 is a bearing which uses balls as rolling parts between an inner ring and an outer ring for an operation of the bearing, and a cage (retainer) which maintains circumferential distances between the rolling balls is mounted in a general ball bearing.

The ball bearing 1 includes an outer ring 10 having a plurality of outer ring orbit grooves 12 each formed in an inner circumferential surface 11, an inner ring 20 having a plurality of inner ring orbit grooves 22 each formed in an outer circumferential surface 21, a plurality of balls 30 each having an outer ring contact surface 31 coming into contact with the outer ring orbit groove 12 and an inner ring contact surface 32 coming into contact with the inner ring orbit groove 22, and a cage 40 in which a plurality of cage grooves 41 are formed to maintain predetermined intervals between the plurality of balls 30 in a circumferential direction.

The outer ring 10 may have a ring shape, in which the outer ring orbit groove 12 is formed inward, to operate while coming into contact with the rolling ball 30. The inner ring 20 may have a ring shape, in which the inner ring orbit groove 21 is formed outward, to operate while coming into contact with the ball 30. The ball 30 may be positioned between the outer ring 10 and the inner ring 20 and roll between the outer ring orbit groove 12 and the inner ring orbit groove 21.

The outer ring contact surface 31 may come into contact with the outer ring orbit groove 12 to form an outer ring contact angle α. The inner ring contact surface 32 may come into contact the inner ring orbit groove 22 to form an inner ring contact angle β. For example, a difference between the outer ring contact angle α and the inner ring contact angle β may be in the range of 5° to 10°, and the outer ring contact angle α may be greater than the inner ring contact angle β.

The outer ring contact angle α may be defined as an angle α between a radial center line ML crossing a center OB of the ball in a radial direction RD and an outer ring contact line OL connecting the center OB of the ball and an outer ring contact point OP at which the outer ring orbit groove 12 comes into contact with the outer ring contact surface 31. The inner ring contact angle β may be defined as an angle β between the radial center line ML crossing the center OB of the ball in the radial direction RD and an inner ring contact line IL connecting the center OB of the ball and an inner ring contact point IP at which the inner ring orbit groove 22 comes into contact with the inner ring contact surface 32.

One ball 30 may come into contact with four points. Two outer ring contact points OP between the outer ring orbit groove 12 and the outer ring contact surface 31 may be symmetrically provided at two sides with respect to the radial center line ML crossing the center OB of the ball in the radial direction RD. Two inner ring contact points IP between the inner ring orbit groove 22 and the inner ring contact surface 32 may be symmetrically provided at two sides with respect to the radial center line ML crossing the center OB of the ball in the radial direction. In addition, a distance between the two outer ring contact points OP may be greater than a distance between the two inner ring contact points IP.

Referring to FIG. 3, conventionally, contact angles of the ball coming into contact with the inner ring and the outer ring are the same according to the standard production method. Alternatively, according to the embodiment, the outer ring contact angle α formed between the outer ring contact surface 31 and the outer ring orbit groove 12 may be different from the inner ring contact angle β formed between the inner ring contact surface 32 and the inner ring orbit groove 22.

The outer ring contact angle α may be greater than the inner ring contact angle β. For example, the inner ring contact angle β may be set in the range of 30° to 37°, and the ball bearing 1 may be manufactured so that the outer ring contact angle α is greater than the inner ring contact angle β. As an example, the inner ring contact angle β may be in the range of 34° to 36°, and the outer ring contact angle α may be in the range of 37° to 45°. For example, the outer ring contact angle α may be 43°. In this case, an angle 2×α formed by the two outer ring contact points OP and the center OB of the ball may be 1.1 to 1.3 times an angle 2×β formed by the two inner ring contact points IP and the center OB of the ball.

Referring to FIG. 2, when the outer ring contact angle α is greater than the inner ring contact angle β, with respect to the radial center line ML crossing the center OB of the ball in the radial direction, a position of the outer ring contact point OP between the outer ring orbit groove 12 and the outer ring contact surface 31 may be farther away than that of the inner ring contact point IP between the inner ring orbit groove 22 and the inner ring contact surface 32. In addition, with respect to a line perpendicular to the radial center line ML, a position of the inner ring contact point IP may be farther away than that of the outer ring contact point OP. Meanwhile, a line connecting the inner ring contact point IP and the facing outer ring contact point OP, between which the center OB of the ball is interposed, may not cross the center OB of the ball.

As described below, a similitude ratio defined as a ratio of a radius D2 of each of the cage grooves 41 to a diameter D1 of the ball 30 may be in the range of 0.50 to 0.53.

Similitude ratio=(Orbit radius)/(Ball diameter)

For example, in the ball bearing, similitude ratios of the inner ring and the outer ring may be the same as 0.52. As a similitude ratio decreases, durability is improved, and as a similitude ratio increases, a contact area decreases, and thus there may be advantageous for a contact rate and friction.

As an example, the outer ring contact angle α may be in the range of 40° to and the similitude ratio defined as the ratio of the radius D2 of the cage groove to the diameter D1 of the ball may be in the range of 0.50 to 0.53.

A curvature R1 of the outer ring orbit groove 12 may be smaller than a curvature R2 of the inner ring orbit groove 22. That is, in order to form the outer ring contact angle α to be greater than the inner ring contact angle β, the outer ring orbit groove 12 may have a shape which is open further than the inner ring orbit groove 22.

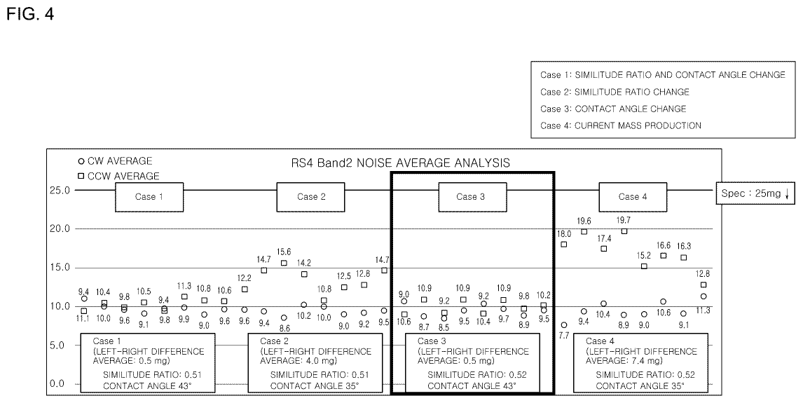

FIG. 4 is a view showing experimental data for describing the performance of the ball bearing according to the embodiment of the present disclosure.

Hereinafter, in Cases 1 to 4, an average of left-right differences was calculated based on a difference between a CW average and a CCW average. In addition, basically, the inner ring contact angle β was 35°.

Case 1 is an example according to the embodiment in which the similitude ratio of the ball bearing was set to 0.51 and the outer ring contact angle α was 43°. In this case, it can be seen that an average of left-right differences of noise is 0.5 mg.

Case 2 is a comparative example in which the similitude ratio of the ball bearing was set to 0.51 and the outer ring contact angle α was 35°. In this case, it can be seen that an average of left-right differences of noise is 4 mg.

Case 3 is an example according to the embodiment in which the similitude ratio of the ball bearing was set to 0.52 and the outer ring contact angle α was 43°. In this case, it can be seen that an average of left-right differences of noise is 0.5 mg.

Case 4 is a comparative example in which the similitude ratio of the ball bearing was set to 0.52 and the outer ring contact angle α was 35°. In this case, it can be seen that an average of left and right differences of noise is 7 mg.

Referring to FIGS. 2 and 4, in the embodiment, the inner ring contact angle β may be 35°, and the outer ring contact angle α may be in the range of 40° to 45°. In addition, in the embodiment, the similitude ratio defined as the ratio of the radius D2 of the cage groove to the diameter D1 of the ball may be in the range of 0.51 to 0.52.

As in the embodiment, when the outer ring contact angle α is greater than the inner ring contact angle β, it can be seen that a left-right difference in noise is improved compared to a case in which the outer ring contact angle α is equal to the inner ring contact angle β. In addition, when the left-right difference in noise is improved, durability improvement can be expected, and quality improvement can be achieved without changing manufacturing costs.

A ball bearing according to an embodiment of the present disclosure can have improved durability because a contact angle of an outer ring is formed to be greater than a contact angle of an inner ring so as to reduce a left-right difference in noise.

The quality of a ball bearing according to an embodiment of the present disclosure can be improved without a change in costs even in a state in which an additional structure is not provided.

While the present disclosure has been described with reference to embodiments illustrated in the accompanying drawings, the embodiments are merely exemplary. It will be understood by those skilled in the art that various modifications and other equivalent example embodiments may be made from the embodiments of the present disclosure. Therefore, the scope of the present disclosure is defined by the appended claims.

What is claimed is:

1. A ball bearing comprising:
an outer ring having a plurality of outer ring orbit grooves formed in an inner circumferential surface of the outer ring;
an inner ring having a plurality of inner ring orbit grooves formed in an outer circumferential surface of the inner ring;
a plurality of balls rotatably disposed between the outer ring and the inner ring; and
a cage having a plurality of cage grooves to maintain intervals between the plurality of balls,
wherein an outer ring contact angle of an outer ring contact point where one of the outer ring orbit grooves contacts one of the balls is different from an inner ring contact angle of an inner ring contact point where one of the inner ring orbit grooves contacts the one of the balls.

2. The ball bearing of claim 1, wherein the outer ring contact angle of the outer ring contact point where the one of the outer ring orbit grooves contacts the one of the balls is greater than the inner ring contact angle of the inner ring contact point where the one of the inner ring orbit grooves contacts the one of the balls.

3. The ball bearing of claim 1, wherein the outer ring contact angle of the outer ring contact point where the one of the outer ring orbit grooves contacts the one of the balls is defined as an angle between a radial center line crossing a center of the one of the balls and an outer ring contact line connecting the center of the one of the balls and the outer ring contract point where the one of the outer ring orbit grooves contacts the one of the balls.

4. The ball bearing of claim 1, wherein the inner ring contact angle of the inner ring contact point where the one of the inner ring orbit grooves contacts the one of the balls is defined as an angle between a radial center line crossing a center of the one of the balls and an inner ring contact line connecting the center of the one of the balls and the inner ring contact point where the one of the inner ring orbit grooves contacts the one of the balls.

5. The ball bearing of claim 1, wherein:
the inner ring contact angle of the inner ring contact point where the one of the inner ring orbit grooves contacts the one of the balls is in a range of 34° to 36°; and
the outer ring contact angle of the outer ring contact point where the one of the outer ring orbit grooves contacts the one of the balls is in a range of 37° to 45°.

6. The ball bearing of claim 1, wherein a ratio of a radius of one of the cage grooves to a diameter of the one of the balls is in a range of 0.50 to 0.53.

7. The ball bearing of claim 1, wherein, with respect to a radial center line crossing a center of the one the balls, the outer ring contact point where the one of the outer ring orbit grooves contacts the one of the balls is farther away than the inner ring contact point where the one of the inner ring orbit grooves contacts the one of the balls.

8. The ball bearing of claim 1, wherein the one of the balls contacts the outer ring orbit grooves at two outer ring contact points including the outer ring contact point at one side and another outer ring contact point at another side with respect to a radial center line crossing a center of the one of the balls.

9. The ball bearing of claim 1, wherein the one of the balls contacts the inner ring orbit grooves at two inner ring contact points including the inner ring contact point at one side and another inner ring contact point at another side with respect to a radial center line crossing a center of the one of the balls.

10. The ball bearing of claim 1, wherein:
the outer ring contact angle of the outer ring contact point where the one of the outer ring orbit grooves contacts the one of the balls is in a range of 40° to 45°; and
a ratio of a radius of one of the cage grooves to a diameter of the one of the balls is in a range of 0.50 to 0.53.

11. The ball bearing of claim 1, wherein a curvature of one of the outer ring orbit grooves is smaller than a curvature of one of the inner ring orbit grooves.

12. A ball bearing comprising:
an outer ring having a plurality of outer ring orbit grooves formed in an inner circumferential surface of the outer ring;
an inner ring having a plurality of inner ring orbit grooves formed in an outer circumferential surface of the inner ring;
a plurality of balls rotatably disposed between the outer ring and the inner ring; and
a cage having a plurality of cage grooves to maintain intervals between the plurality of balls,
wherein a difference between an outer ring contact angle of an outer ring contact point where one of the outer ring orbit grooves contacts one of the balls and an inner ring contact angle of an inner ring contact point where one of the inner ring orbit grooves contacts the one of the balls is in a range of 5° to 10°.

13. The ball bearing of claim 12, wherein:
the inner ring contact angle of the inner ring contact point where the one of the inner ring orbit grooves contacts the one of the balls is 35°; and
the outer ring contact angle of the outer ring contact point where the one of the outer ring orbit grooves contacts the one of the balls is in a range of 40° to 45°.

14. The ball bearing of claim 12, wherein:
the inner ring contact angle of the inner ring contact point where the one of the inner ring orbit grooves contacts the one of the balls is 35°; and
the outer ring contact angle of the outer ring contact point where the one of the outer ring orbit grooves contacts the one of the balls is 43°.

15. The ball bearing of claim 12, wherein:
the one of the balls contacts the outer ring orbit grooves at two outer ring contact points including the outer ring contact point at one side and another outer ring contact point at another side and being symmetric with respect to a radial center line crossing a center of the one of the balls; and
the one of the balls contacts the inner ring orbit grooves at two inner ring contact points including the inner ring contact point at one side and another inner ring contact point at another side and being symmetric with respect to the radial center line crossing the center of the one of the balls.

16. The ball bearing of claim 15, wherein, with respect to a line perpendicular to the radial center line, the inner ring contact point where the one of the inner ring orbit grooves contacts the one of the balls is farther away than the outer ring contact point where the one of the outer ring orbit grooves contacts the one of the balls.

17. The ball bearing of claim 15, wherein a line connecting the outer ring contact point and the inner ring contact point, or the another outer ring contact point and the another inner ring contact point, between which the center of the one of the balls is interposed does not cross the center of the one of the balls.

18. The ball bearing of claim 15, wherein a distance between the two outer ring contact points is greater than a distance between the two inner ring contact points.

19. The ball bearing of claim 15, wherein an angle between the two outer ring contact points with respect to the center of the one of the balls is 1.1 to 1.3 times an angle between the two inner ring contact points with respect to the center of the one of the balls.

20. The ball bearing of claim 12, wherein a ratio of a radius of one of the cage grooves to a diameter of the one of the balls is in a range of 0.51 to 0.52.
